(19) United States
(12) Patent Application Publication
(10) Pub. No.: US 2013/0219678 A1
(43) Pub. Date: Aug. 29, 2013

(54) Clamping And Sliding Device For Polygonal Shaft

(71) Applicant: Patrick Daniel Brewster, Boyertown, PA (US)

(72) Inventor: Patrick Daniel Brewster, Boyertown, PA (US)

(21) Appl. No.: 13/766,808

(22) Filed: Feb. 14, 2013

Related U.S. Application Data
(60) Provisional application No. 61/604,468, filed on Feb. 28, 2012.

(51) Int. Cl. F16B 2/06

(52) U.S. Cl. CPC F16B 2/065
USPC 24/486

(57) ABSTRACT

Apparatuses and methods consistent with the present inventive concept relate to a clamping device which is connectable with a shaft having a longitudinal axis and four longitudinal surfaces extending in a direction parallel to the longitudinal axis, the clamping device including: a base member having two substantially perpendicular surfaces, the base member being configured to contact two adjacent longitudinal surfaces of said four longitudinal surfaces of said shaft, wherein said base member extends along the shaft in the direction parallel to the longitudinal axis; and a plurality of clamping elements, the plurality of clamping elements being coupled to said base member, wherein each of the plurality of clamping elements is flexible in a direction substantially perpendicular to the longitudinal axis of the shaft, and the plurality of clamping elements is operable to exert clamping pressure on the two adjacent longitudinal surfaces of said shaft opposing the base member.

Patrick Brewster 19

### CROSS-REFERENCE TO RELATED APPLICATIONS

This application claims priority from U.S. Provisional Patent Application 61/604468 filed on Feb. 28, 2012.

### BACKGROUND

The present inventive concept relates to a positioning apparatus including a polygonal shaft and at least one mating device, which are connectable and configured to clamp onto the shaft.

In any application requiring linear motion, such as machinery, optics, or medical devices, uniaxial positioning systems may be utilized to provide the required motion. Uniaxial positioning systems are typically composed of dovetail assemblies, shafts and mating bearings or rails and mating carriages, and typically include a means to propel and/or brake the moveable components. Often a mechanism that exerts a clamping pressure onto the shaft is used as the brake. Uniaxial positioning systems composed of shafts generally make use of bearings with rolling elements, such as balls; or sliding elements, such as low-friction liners. The latter are typically known as plain bearings.

Round shafts are often utilized due to ease of manufacture of both the shaft and mating components. However, two round shafts are required to restrict the motion to one linear axis, and the use of two shafts presents numerous problems and costs. For example, the alignment of the shafts must be extremely accurate to avoid binding of the sliding components. However, in the related art, the use of two shafts incurs both the cost of the hardware required to mount them, and the cost of achieving or compensating for the lack of necessary alignment. Furthermore, dual-shaft assemblies may be too large for applications with particular dimensional constraints.

A single polygonal shaft, on the other hand, when coupled with appropriate mounting hardware and at least one sliding bearing or clamping device with a mating aperture, can provide uniaxial motion. The use of such a system eliminates the aforementioned costs related to dual-shaft systems, and consumes less space than an equivalent dual-shaft system. Square or hexagonal shafts are typically preferred due to manufacturing ease and commercial availability.

A related art V-block with clamping accessory, such as shown in FIGS. 1 and 2, can clamp onto and slide along a square shaft. However, the clamping force is applied by a set-screw, which presents numerous problems. First, a set-screw applies its pressure in one location, which may create an indentation or otherwise damage the shaft surface. Second, the set-screw, when loose, is free to deflect in the direction of travel. As a result, the set-screw may bind and chatter when the V-block slides along the shaft.

A related art square shaft clamp can also clamp onto and slide along a square shaft. However, the clamping force is applied primarily to the two corners of the shaft closest to the pinch bolt, potentially resulting in shaft damage and an unsatisfactory clamping engagement.

Still other related art includes a square shaft clamp, which can clamp onto and slide along a square shaft, and it applies the clamping force over a large surface area of the shaft. However, because the base member and clamping elements form an aperture that is larger than the shaft profile, the shaft is not forced into repeatable alignment with the base member upon tightening of the pinch bolt. Therefore true uniaxial motion is not achieved. Furthermore, the clamping elements are free to move slightly in the direction of travel when the pinch bolt is loose. As a result, the clamping elements may bind and chatter when the device slides along the shaft.

Other related art discloses a clamp for a square shaft that is actuated by one pinch bolt. However, the clamping pressure is transferred from the pinch bolt and nut to the housing, then to the clamping elements, and finally to the shaft. The deformation of the housing and clamping elements that is necessary to achieve clamping engagement is unpredictable and unrepeatable. Therefore, a consistent positional relationship between the shaft and the device is not maintained through repeated actuations of the pinch bolt. This consistent positional relationship is critical in linear motion applications.

Still other related art discloses a similar clamp for a square shaft that is actuated by two pinch bolts. Although effective, the operation of two pinch bolts is burdensome to the user.

### SUMMARY

The present inventive concept includes a clamping device which is capable of clamping onto and sliding along a mating polygonal shaft.

### BRIEF DESCRIPTION OF THE DRAWINGS

FIG. 1 shows an end view of a related art clamping device typically referred to as a V-block.

FIG. 2 shows a perspective view of a related art clamping device typically referred to as a V-block.

FIG. 3 shows an end view of a related art clamping device.

FIG. 4 shows a perspective view of a related art clamping device.

FIG. 5 shows an end view of an exemplary embodiment consistent with the inventive concept. The shaft is shown.

FIG. 6 shows a detail view of an exemplary embodiment consistent with the inventive concept. The shaft is shown.

FIG. 7 shows a perspective view of an exemplary embodiment consistent with the inventive concept. The shaft is not shown.

FIG. 8 shows an end view of another exemplary embodiment consistent with the inventive concept. The shaft is shown.

FIG. 9 shows a detail view of an exemplary embodiment consistent with the inventive concept. The shaft is shown.

FIG. 10 shows a perspective view of an exemplary embodiment consistent with the inventive concept. The shaft is not shown.

FIG. 11 shows an end view of another exemplary embodiment consistent with the inventive concept. The shaft is shown.

FIG. 12 shows a perspective view of an exemplary embodiment consistent with the inventive concept. The shaft is not shown.

FIG. 13 shows an end view of another exemplary embodiment consistent with the inventive concept. The shaft is shown.

FIG. 14 shows a detail view of an exemplary embodiment consistent with the inventive concept. The shaft is shown.

FIG. 15 shows a perspective view of an exemplary embodiment consistent with the inventive concept. The shaft is not shown.

FIG. 16 shows an end view of another exemplary embodiment consistent with the inventive concept. The shaft is shown.

FIG. 17 shows a detail view of an exemplary embodiment consistent with the inventive concept. The shaft is shown.

FIG. 18 shows a perspective view of an exemplary embodiment consistent with the inventive concept. The shaft is not shown.

FIG. 19 shows an end view of another exemplary embodiment consistent with the inventive concept. The shaft is shown.

FIG. 20 shows a perspective view of an exemplary embodiment consistent with the inventive concept. The shaft is not shown.

FIG. 21 shows an end view of another exemplary embodiment consistent with the inventive concept. The shaft is shown.

FIG. 22 shows a perspective view of an exemplary embodiment consistent with the inventive concept. The shaft is not shown.

FIG. 23 shows an end view of another exemplary embodiment consistent with the inventive concept. The shaft is shown.

FIG. 24 shows a detail view of an exemplary embodiment consistent with the inventive concept. The shaft is shown.

FIG. 25 shows a perspective view of an exemplary embodiment consistent with the inventive concept. The shaft is not shown.

FIG. 26 shows an end view of another exemplary embodiment consistent with the inventive concept. The shaft is shown.

FIG. 27 shows a perspective view of an exemplary embodiment consistent with the inventive concept. The shaft is not shown.

FIG. 28 shows a perspective view of an exemplary embodiment consistent with the inventive concept. The shaft is not shown.

FIG. 29 shows an end view of another exemplary embodiment consistent with the inventive concept. The shaft is shown.

FIG. 30 shows a detail view of an exemplary embodiment consistent with the inventive concept. The shaft is shown.

FIG. 31 shows a perspective view of an exemplary embodiment consistent with the inventive concept. The shaft is not shown.

FIG. 32 shows an end view of another exemplary embodiment consistent with the inventive concept. The shaft is shown.

FIG. 33 shows a detail view of an exemplary embodiment consistent with the inventive concept. The shaft is shown.

FIG. 34 shows a perspective view of an exemplary embodiment consistent with the inventive concept. The shaft is not shown.

FIG. 35 shows an end view of another exemplary embodiment consistent with the inventive concept. The shaft is shown.

FIG. 36 shows a detail view of an exemplary embodiment consistent with the inventive concept. The shaft is shown.

FIG. 37 shows a perspective view of an exemplary embodiment consistent with the inventive concept. The shaft is not shown.

FIG. 38 shows an end view of another exemplary embodiment consistent with the inventive concept. The shaft is shown.

FIG. 39 shows a detail view of an exemplary embodiment consistent with the inventive concept. The shaft is shown.

FIG. 40 shows a perspective view of an exemplary embodiment consistent with the inventive concept. The shaft is not shown.

FIG. 41 shows an end view of another exemplary embodiment consistent with the inventive concept. The shaft is shown.

FIG. 42 shows a detail view of an exemplary embodiment consistent with the inventive concept. The shaft is shown.

FIG. 43 shows an end view of the shaft of an exemplary embodiment consistent with the inventive concept.

FIG. 44 shows a perspective view of an exemplary embodiment consistent with the inventive concept. The shaft is not shown.

FIG. 45 shows an end view of another exemplary embodiment consistent with the inventive concept. The shaft is shown.

FIG. 46 shows a detail view of an exemplary embodiment consistent with the inventive concept. The shaft is shown.

FIG. 47 shows an end view of the shaft of an exemplary embodiment consistent with the inventive concept.

FIG. 48 shows a perspective view of an exemplary embodiment consistent with the inventive concept. The shaft is not shown.

FIG. 49 shows an end view of another exemplary embodiment consistent with the inventive concept. The shaft is shown.

FIG. 50 shows a detail view of an exemplary embodiment consistent with the inventive concept. The shaft is shown.

FIG. 51 shows an end view of the shaft of an exemplary embodiment consistent with the inventive concept.

FIG. 52 shows a perspective view of an exemplary embodiment consistent with the inventive concept. The shaft is not shown.

FIG. 53 shows an end view of another exemplary embodiment consistent with the inventive concept. The shaft is shown.

FIG. 54 shows a detail view of an exemplary embodiment consistent with the inventive concept. The shaft is shown.

FIG. 55 shows an end view of an exemplary embodiment consistent with the inventive concept. The shaft is not shown.

FIG. 56 shows an end view of the shaft of an exemplary embodiment consistent with the inventive concept.

FIG. 57 shows an end view of another exemplary embodiment consistent with the inventive concept. The shaft is shown.

FIG. 58 shows a detail view of an exemplary embodiment consistent with the inventive concept. The shaft is shown.

FIG. 59 shows an end view of an exemplary embodiment consistent with the inventive concept. The shaft is not shown.

FIG. 60 shows an end view of the shaft of an exemplary embodiment consistent with the inventive concept.

FIG. 61 shows an end view of another exemplary embodiment consistent with the inventive concept. The shaft is shown.

FIG. 62 shows a detail view of an exemplary embodiment consistent with the inventive concept. The shaft is shown.

FIG. 63 shows an end view of an exemplary embodiment consistent with the inventive concept. The shaft is not shown.

FIG. 64 shows an end view of the shaft of an exemplary embodiment consistent with the inventive concept.

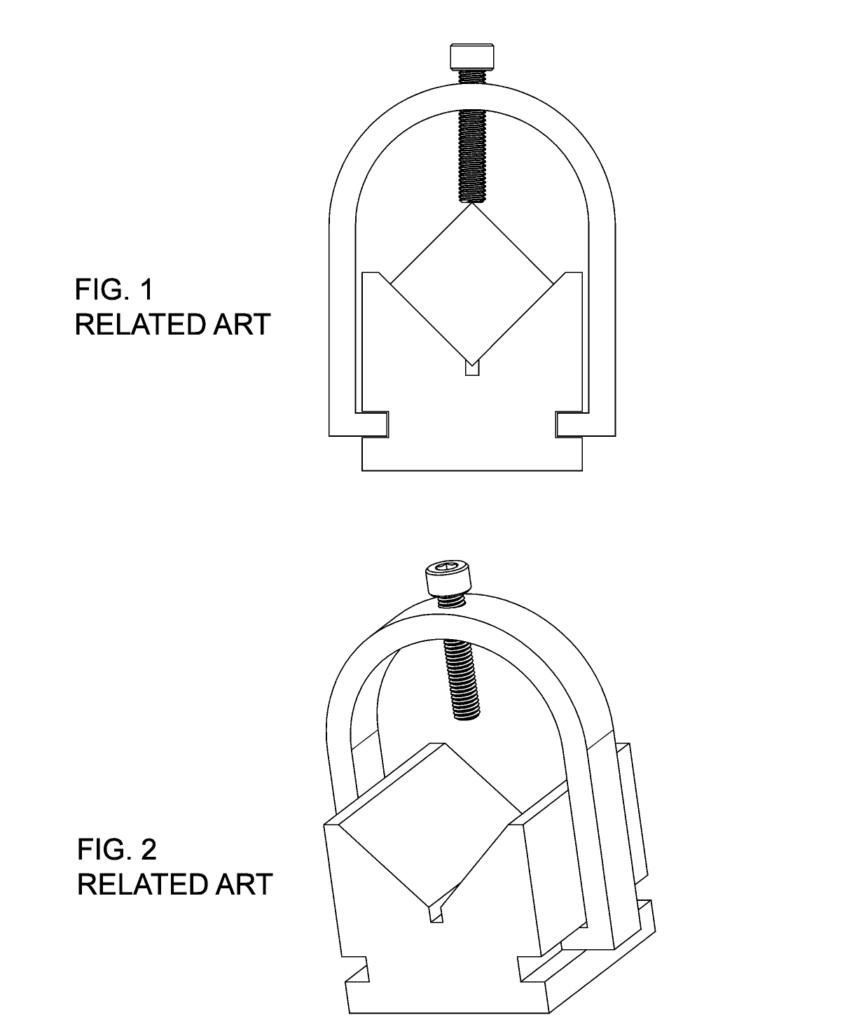

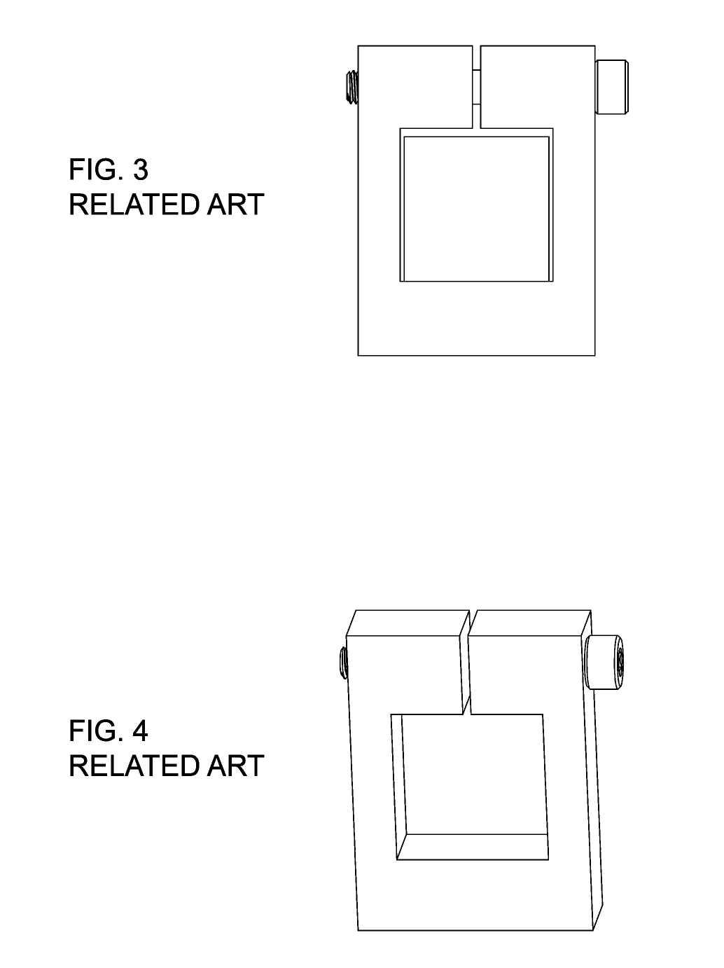

### DETAILED DESCRIPTION

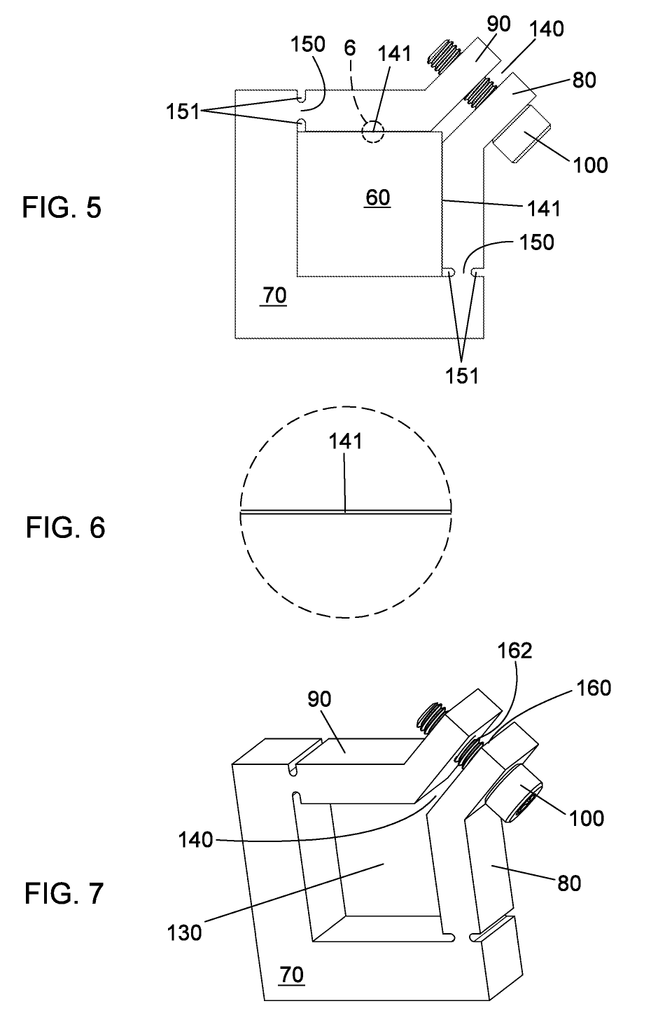

As shown in FIGS. 5, 6, and 7 an exemplary embodiment includes a shaft 60, a base member 70, and clamping elements 80, 90 that may be composed of one solid piece of material. Further, the shaft 60 may be square, such as shown. The clamping elements are spaced by gap 140. Pinch bolt 100 passes through bolt hole 160 in clamping element 80 and mates with threaded hole 162 in clamping element 90. Recesses 151 may be provided at the junction of the clamping elements and the base member to allow the clamping elements to pivot with ease at live hinge points 150.

The configuration of the base member and clamping elements is such that an aperture 130, with geometry that mates with the shaft 60, is provided. More particularly, each interior surface of the base member mates with one of two adjacent sides of the shaft, while each interior surface of the clamping elements mates with one of the two remaining sides of the shaft. The dimensional relationship between the aperture and the shaft is such that the gaps 141 offer a minimal clearance, permitting unlimited linear, but limited rotational motion along the shaft axis when the pinch bolt is loose.

When the pinch bolt is tightened, the clamping elements flex at live hinge points 150, and gaps 141 diminish in size, restricting rotational motion. With further tightening, the clamping elements make contact with the shaft and force the shaft into locking engagement and repeatable alignment with the base member.

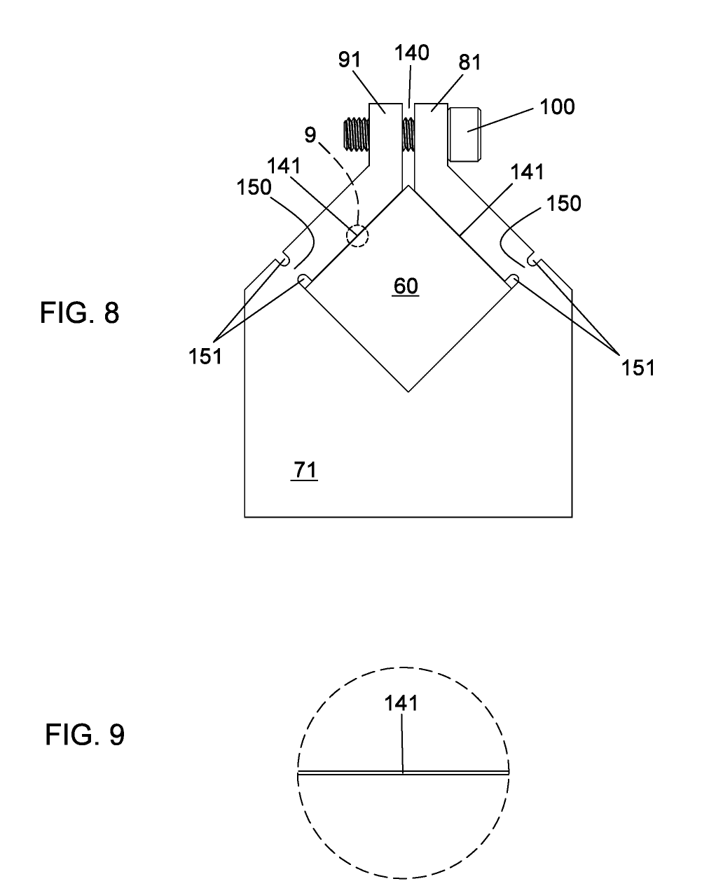

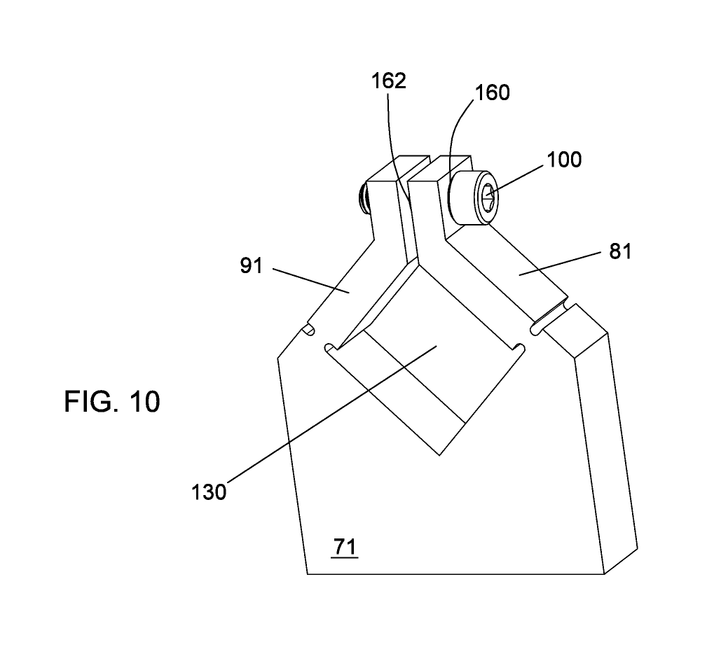

FIGS. 8, 9, and 10 show an embodiment consistent with the inventive concept that is similar to that shown in FIGS. 5, 6, and 7, except that the shaft orientation is different and the base member 71 and clamping elements 81, 91 are shaped accordingly.

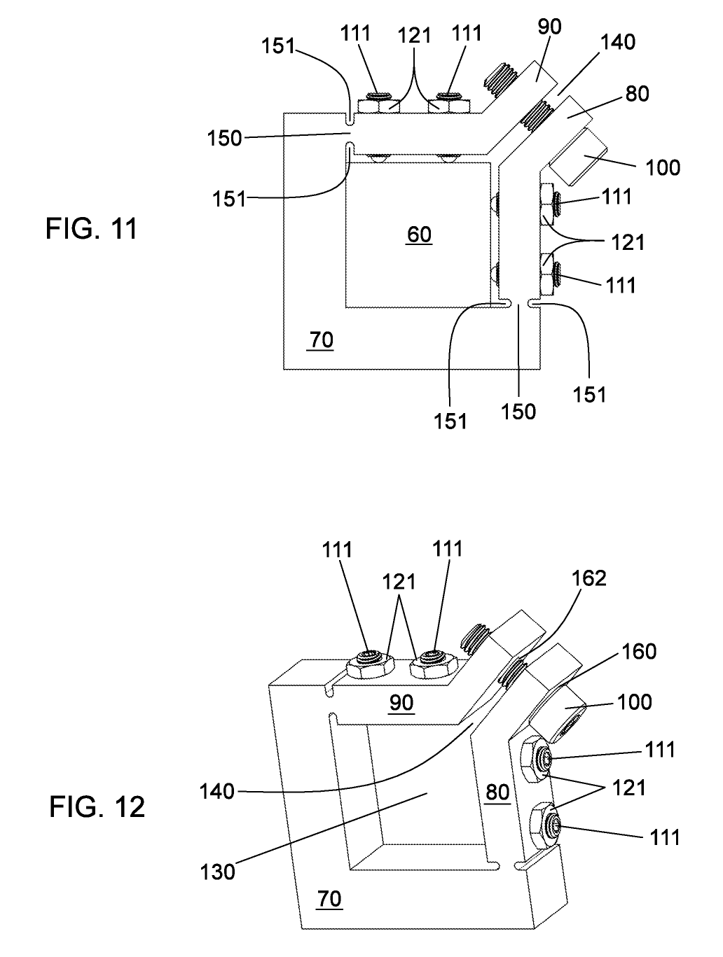

FIGS. 11 and 12 show an embodiment consistent with the inventive concept that is similar to that shown in FIGS. 5, 6, and 7, except that the clamping elements include set-screws 111, the tips of which make contact with the shaft upon actuation of the pinch bolt 100. When the pinch bolt is loose, the user may adjust the set-screws to achieve the desired running clearance between the shaft 60 and the clamping device. Nuts 121 may be provided to lock the set-screws in their desired positions. The provision of the set-screws allows this embodiment to accommodate a range of shaft sizes or dimensional tolerances, and permits the inner surfaces of the clamping elements to be manufactured with a rough finish or imprecise dimensions. These virtues may reduce manufacturing costs and expand usefulness. Set-screws are commercially available with special tips such as rolling balls, as shown in FIGS. 11 and 12, or low-friction pads. The manufacturer or one skilled in the art may designate the optimal type, quantity, and placement of the set-screws.

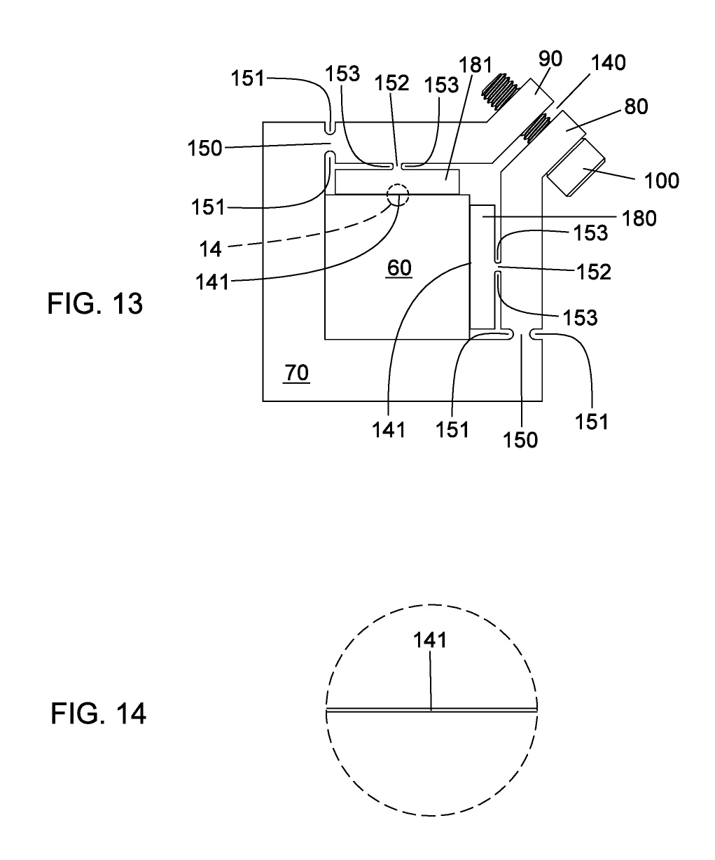

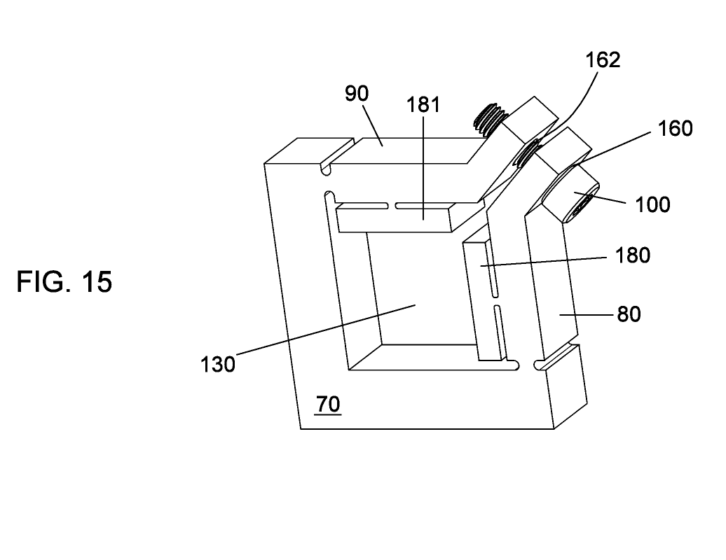

FIGS. 13, 14, and 15 show an embodiment consistent with the inventive concept that is similar to that shown in FIGS. 5, 6, and 7, except that the clamping elements 80, 90 are provided with clamping pads 180, 181 which are free to pivot at live hinge points 152 by virtue of recesses 153. The provision of pivoting clamping pads ensures that the clamping pressure exerted on the shaft 60 is evenly distributed and widespread.

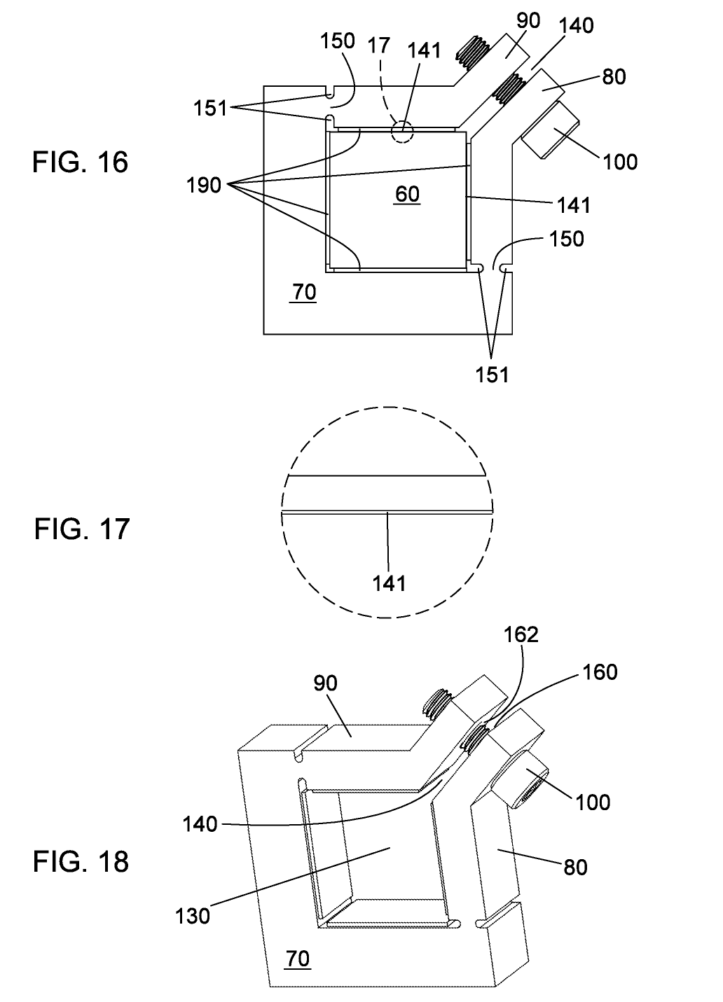

FIGS. 16, 17, and 18 show an embodiment consistent with the inventive concept that is similar to that shown in FIGS. 5, 6, and 7, except that four sliding elements 190 are adhered or coupled to the interior surfaces of the base member 70 and clamping elements 80, 90, providing four sliding surfaces which mate with the four sides of shaft 60. The sliding elements may be composed of any suitable low-friction material such as polytetrafluoroethylene, polyoxymethylene, a blend thereof, or brass. The provision of sliding elements allows the clamping device to slide freely along the shaft.

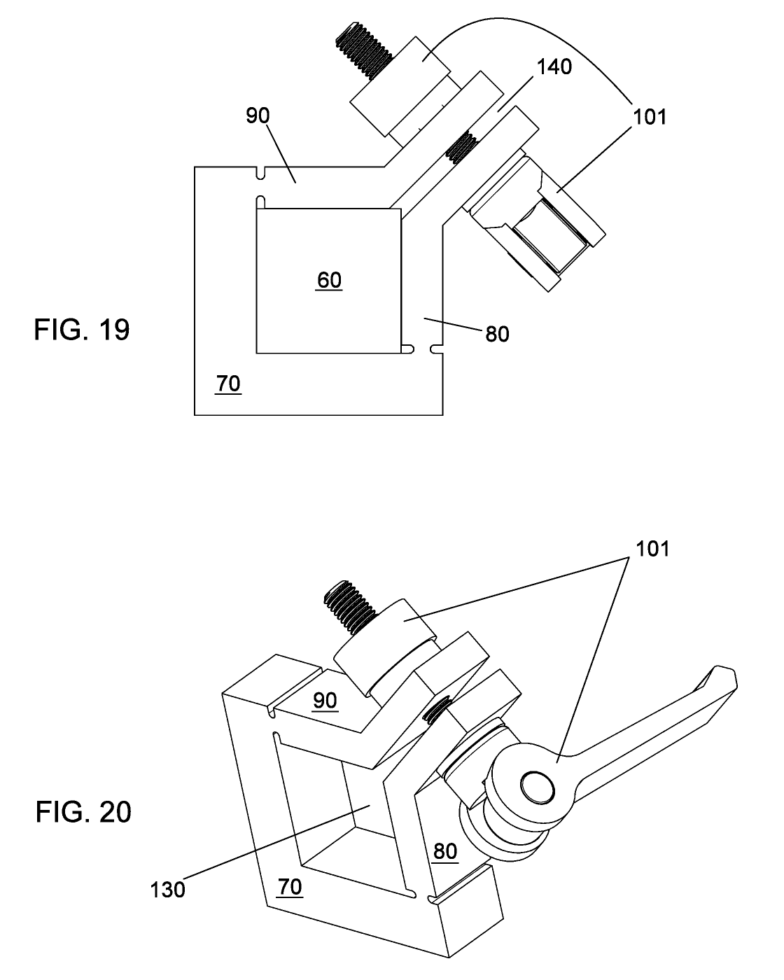

FIGS. 19 and 20 show an embodiment consistent with the inventive concept that is similar to that shown in FIGS. 5, 6, and 7, except that a commercially available cam mechanism 101 is used to move the clamping elements 80, 90 into locking engagement with the shaft 60. The manufacturer or one skilled in the art may substitute any such device, including but not limited to a hydraulic, pneumatic, or electromagnetic piston, in place of the cam mechanism.

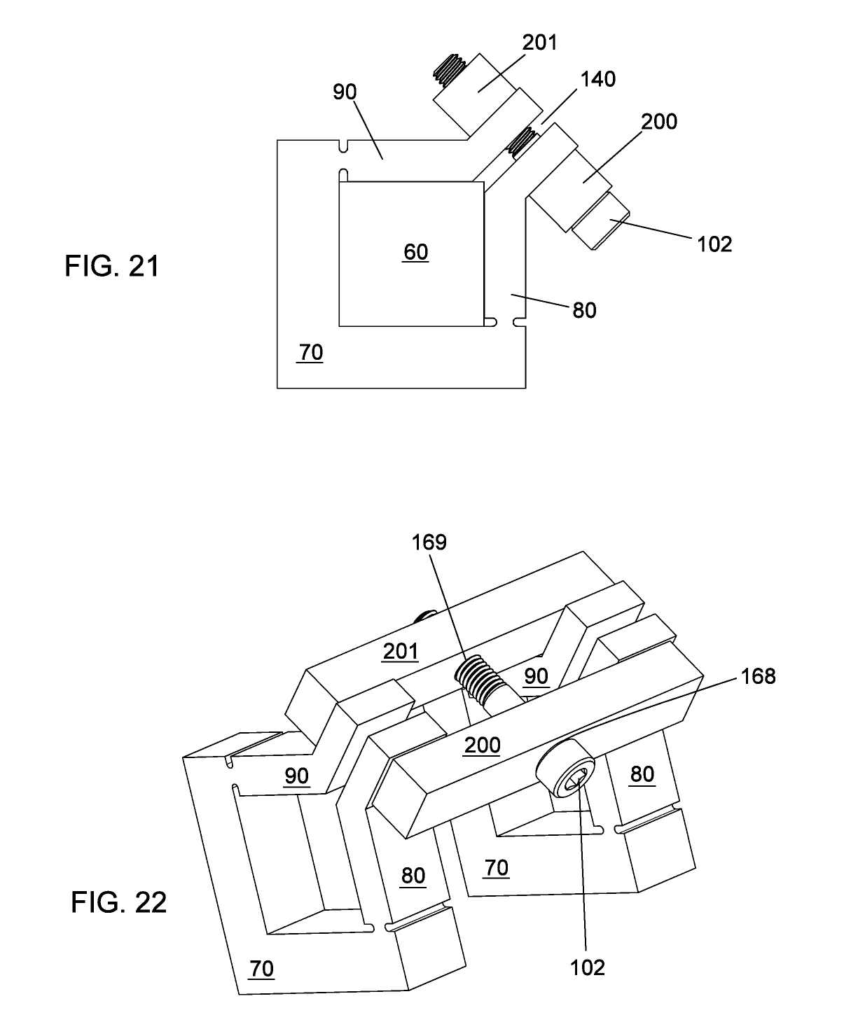

FIGS. 21 and 22 show an embodiment consistent with the inventive concept that is similar to that shown in FIGS. 5, 6, and 7, except that two clamping devices are ganged together by pinch bars 200, 201, and actuated by a single pinch bolt 102. Pinch bolt 102 passes through bolt hole 168 in pinch bar 200, and mates with threaded hole 169 in pinch bar 201. The pinch bars may be coupled to clamping elements 80, 90 by any appropriate means.

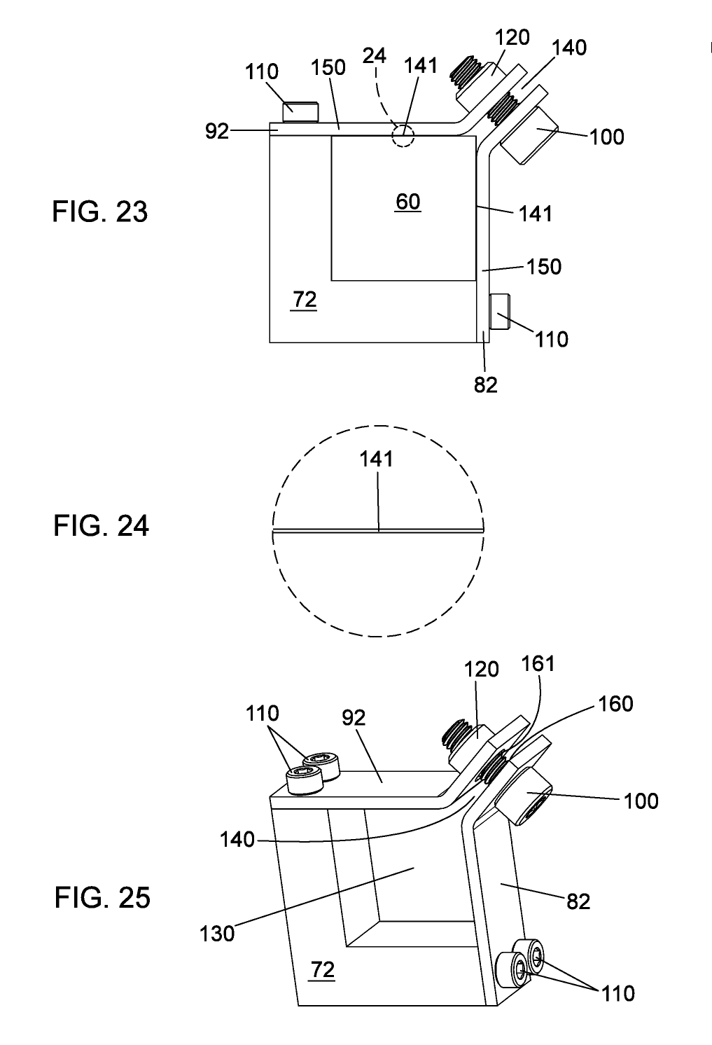

FIGS. 23, 24, and 25 show an embodiment consistent with the inventive concept that is similar to that shown in FIGS. 5, 6, and 7, except that the base member 72 and clamping elements 82, 92 are separate components. Clamping elements 82, 92, which are preferably formed from sheet metal, may be coupled to base member 72 with coupling screws 110 or other appropriate means, such as welding. Pinch bolt 100 passes through bolt hole 160 in clamping element 82, bolt hole 161 in clamping element 92, and mates with threaded nut 120 affixed to clamping element 92.

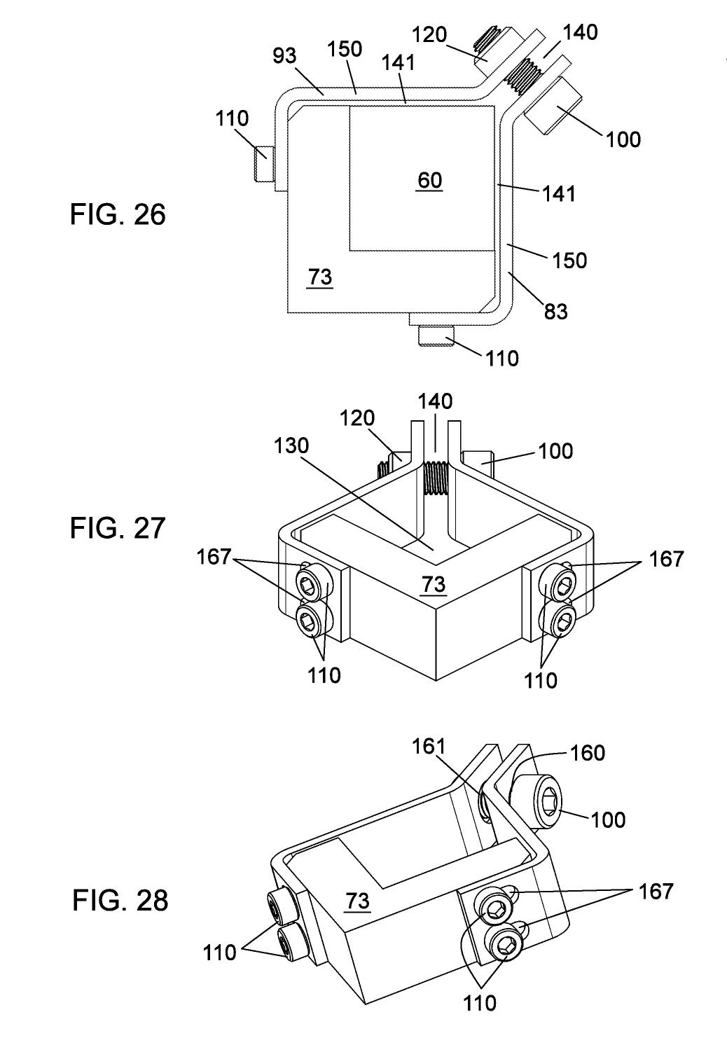

FIGS. 26, 27, and 28 show an embodiment consistent with the inventive concept that is similar to that shown in FIGS. 23, 24, and 25, except that clamping elements 83, 93 are formed and provided with slots 167 such that gaps 141 may be adjusted by loosening coupling screws 110 and moving the clamping elements to the desired position in respect to base member 73. This adjustability allows this embodiment to accommodate a range of shaft sizes or dimensional tolerances, and allows the dimensional accuracy of the components to be less exact than that of a non-adjustable embodiment.

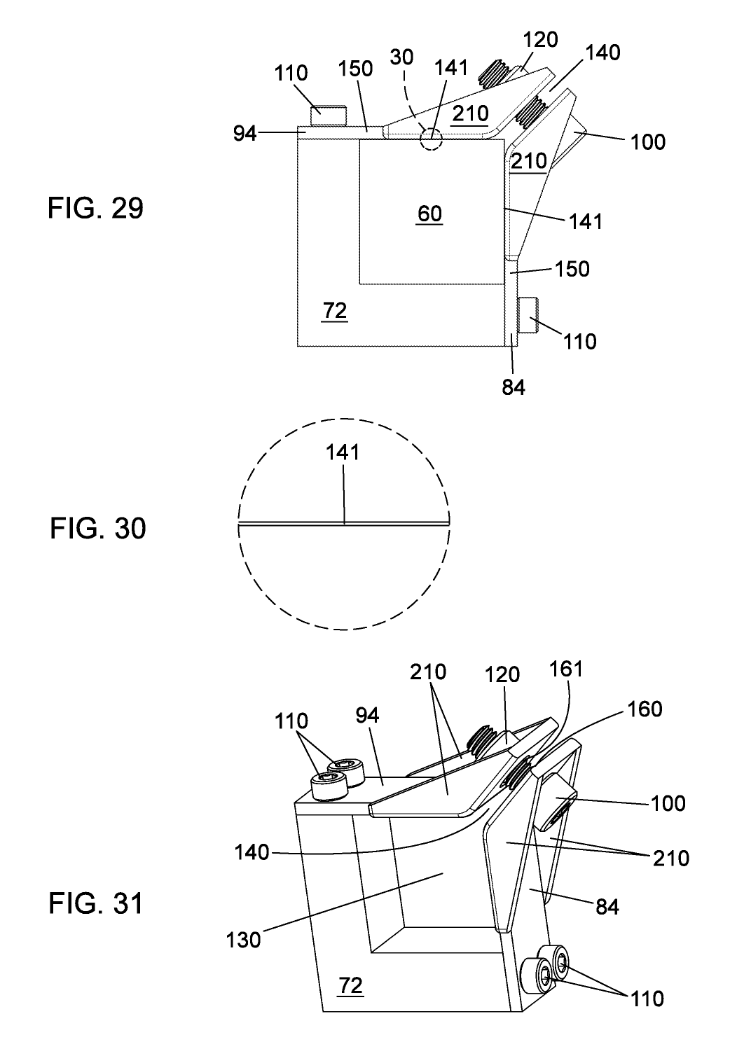

FIGS. 29, 30, and 31 show an embodiment consistent with the inventive concept that is similar to that shown in FIGS. 23, 24, and 25, except that clamping elements 84, 94 are reinforced by gussets 210. The gussets prevent undesired excess deformation or damage of the clamping elements upon actuation of the pinch bolt 100, especially if the pinch bolt is over-tightened. The provision of the gussets may allow the clamping elements to be fabricated from thinner material than an unreinforced embodiment, which in turn may reduce manufacturing costs.

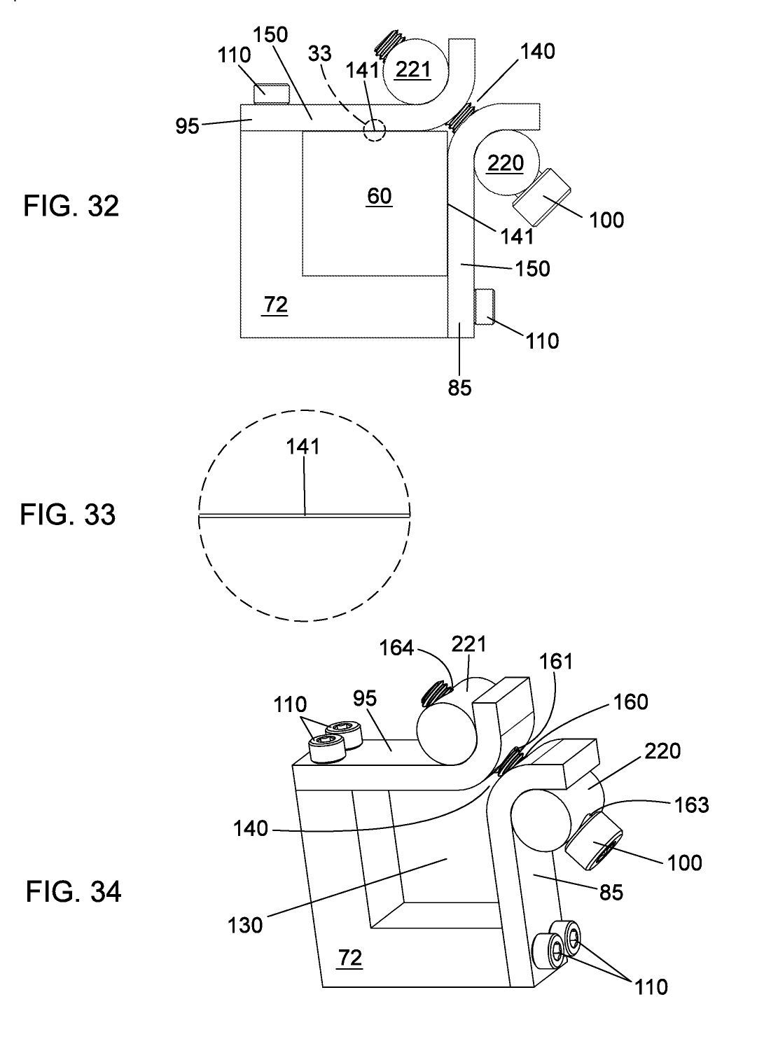

FIGS. 32, 33, and 34 show an embodiment consistent with the inventive concept that is similar to that shown in FIGS. 23, 24, and 25, except that clamping elements 85, 95 are formed so as to mate with a portion of the curved surfaces of cylindrical pinch blocks 220, 221. Pinch bolt 100 passes through bolt hole 163 in pinch block 220, bolt hole 160 in clamping element 85, bolt hole 161 in clamping element 95, and mates with threaded hole 164 in pinch block 221. The cylindrical pinch blocks are free to rotate about their axes, thereby distributing the clamping force of the pinch bolt over a large portion of the clamping element surfaces.

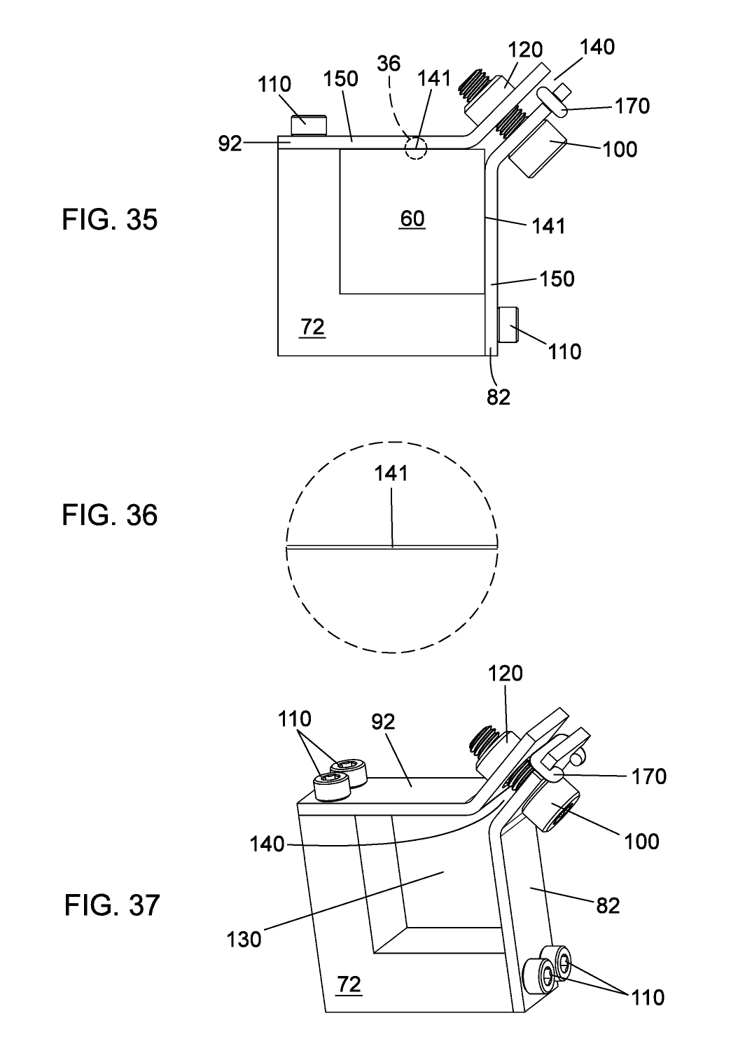

FIGS. 35, 36 and 37 show an embodiment consistent with the inventive concept that is similar to that shown in FIGS. 23, 24, and 25, except that spacing element 170 is affixed to clamping element 82 and positioned such that pinch bolt 100 is in between the spacing element and aperture 130. The spacing element is fabricated and installed such that it protrudes from clamping element 82 toward clamping element 92 across gap 140, and the distance of protrusion is substantially less than the dimension of gap 140. The spacing element serves as a stop for the clamping elements, allowing the clamping elements to move into locking engagement with the shaft, but preventing undesired excess deformation or damage of the clamping elements that may result from over-tightening of the pinch bolt. The spacing element may alternatively be installed such that it protrudes from clamping element 92 toward clamping element 82.

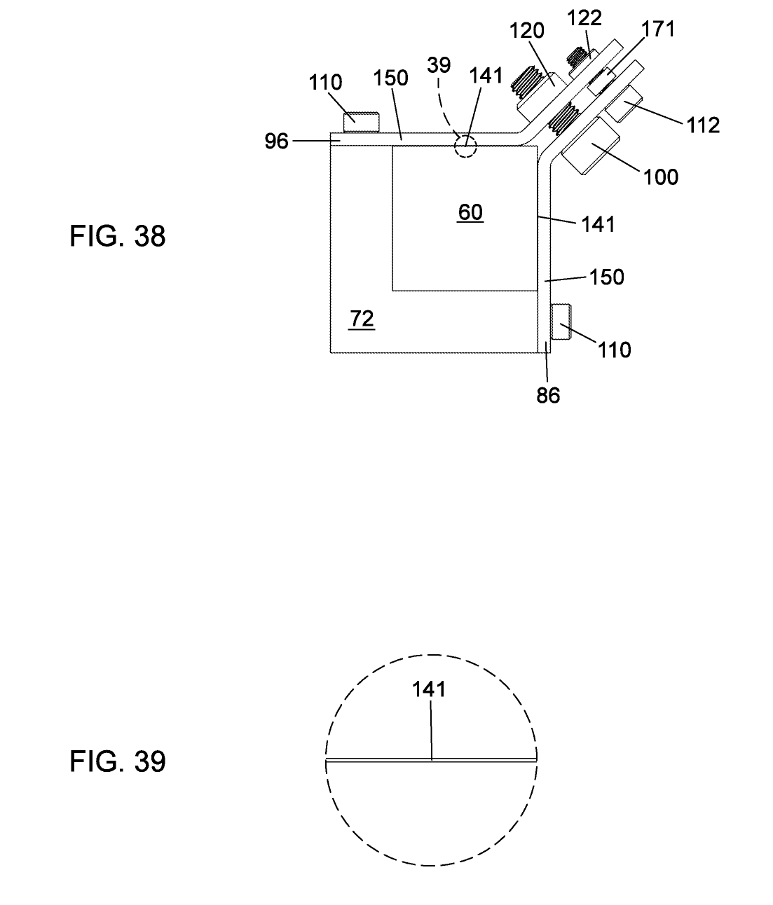

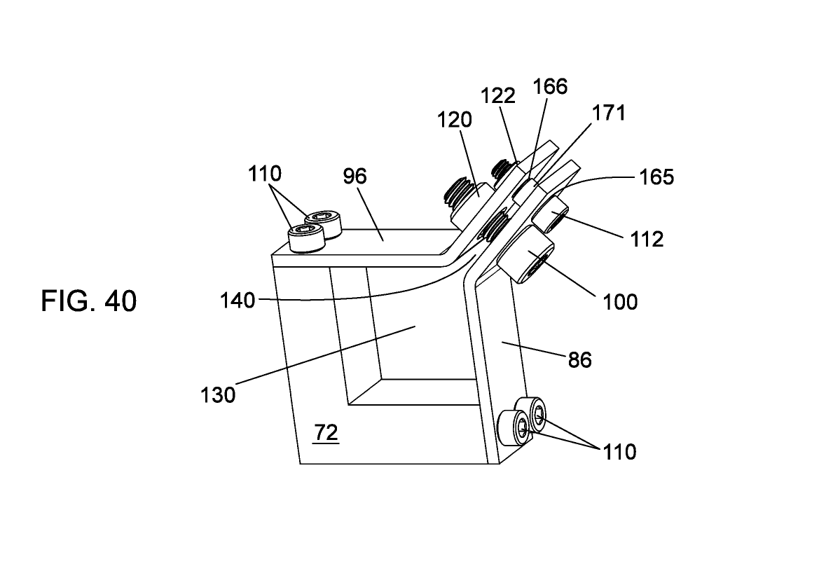

FIGS. 38, 39, and 40 show an embodiment consistent with the inventive concept that is similar to that shown in FIGS. 23, 24, and 25, except that set bolt 112, spacing washer 171 and set nut 122 are provided. Set bolt 112 passes through bolt hole 165 in clamping element 86, spacing washer 171 positioned between the clamping elements 86, 96, bolt hole 166 in clamping element 96, and mates with threaded set nut 122 affixed to clamping element 96. The set bolt, spacing washer and set nut assembly is positioned such that pinch bolt 100 is in between the spacing washer and aperture 130. The spacing washer, which is substantially smaller in length than the dimension of gap 140, serves as a stop for the clamping elements, allowing the clamping elements to move into locking engagement with the shaft, but preventing undesired excess deformation or damage of the clamping elements that may result from over-tightening of the pinch bolt. The set bolt and set nut allow the user to adjust the running clearance of the device by setting gaps 141 to their desired maximum size.

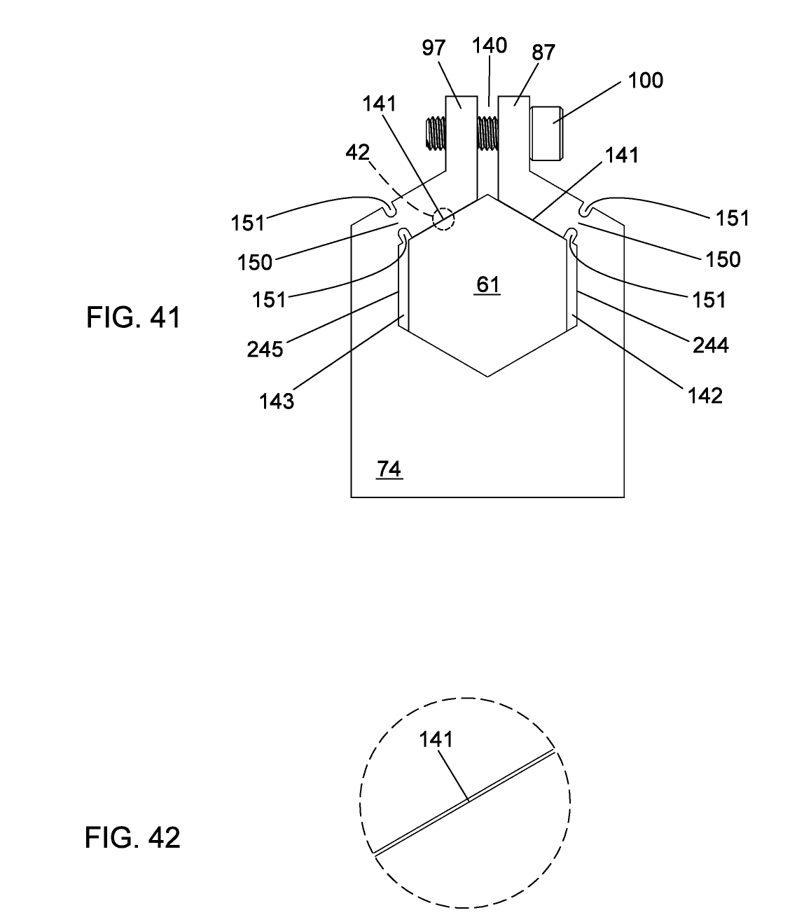

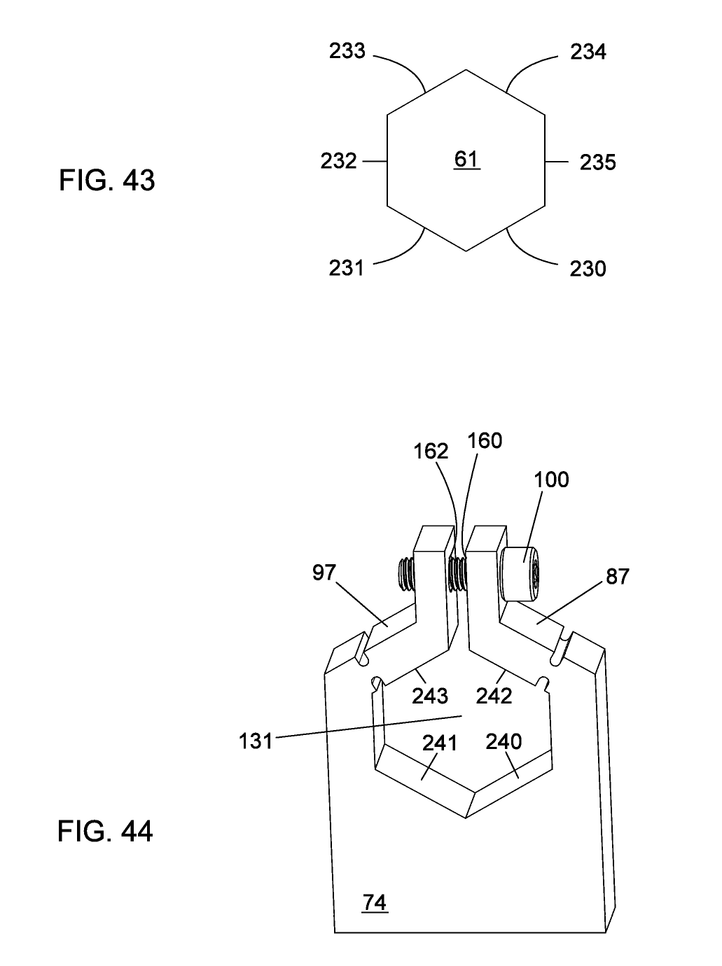

FIGS. 41, 42, 43, and 44 show an embodiment consistent with the inventive concept that is similar to that shown in FIGS. 5, 6, and 7, except that shaft 61 is hexagonal and base member 74 and clamping elements 87, 97 are shaped accordingly. The configuration of the base member and clamping elements is such that an aperture 131, with geometry that mates with the shaft 61, is provided. More particularly, inner base member surfaces 240 and 241 mate with shaft surfaces 230 and 231, respectively, while inner clamping element surfaces 242 and 243 mate with shaft surfaces 234 and 233, respectively. Inner base member surfaces 244 and 245 are spaced from shaft surfaces 235 and 232 by gaps 142 and 143, respectively. The dimensional relationship between the aperture and the shaft is such that gaps 141 offer a minimal clearance, permitting unlimited linear, but limited rotational motion along the shaft axis when the pinch bolt 100 is loose.

When the pinch bolt 100 is tightened, the clamping elements flex at live hinge points 150, and gaps 141 diminish in size, restricting rotational motion. With further tightening, the clamping elements make contact with the shaft and force the shaft into locking engagement and repeatable alignment with the base member.

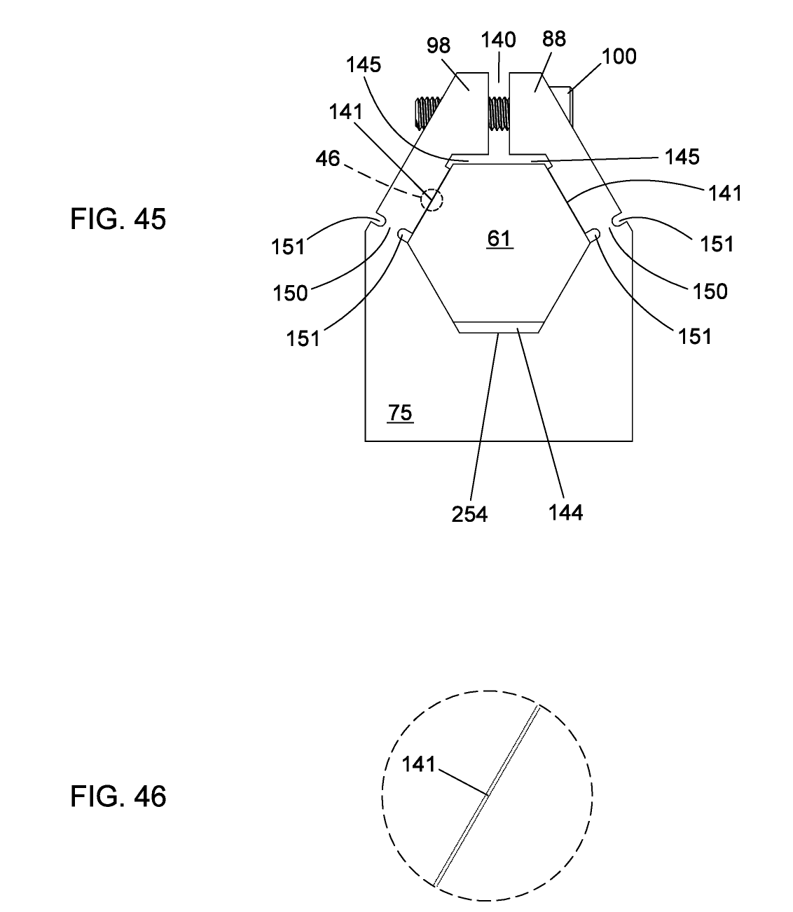

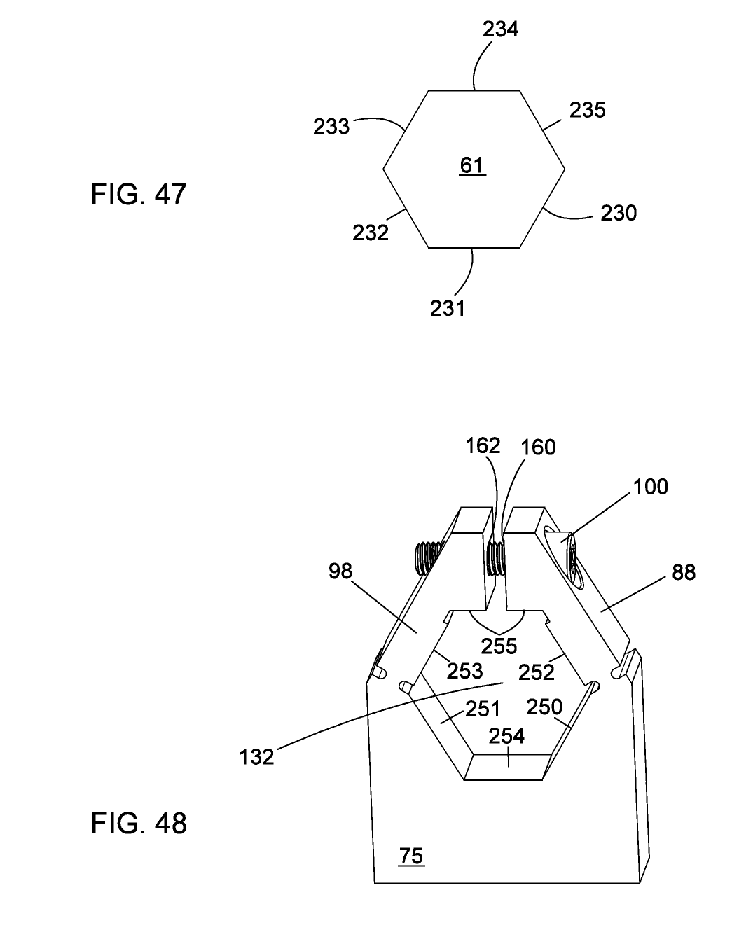

FIGS. 45, 46, 47, and 48 show an embodiment consistent with the inventive concept that is similar to that shown in FIGS. 41, 42, 43, and 44, except that the shaft orientation is different and base member 75 and clamping elements 88, 98 are shaped accordingly. The configuration of the base member and clamping elements is such that an aperture 132, with geometry that mates with the shaft 61, is provided. More particularly, inner base member surfaces 250 and 251 mate with shaft surfaces 230 and 232, respectively, while inner clamping element surfaces 252 and 253 mate with shaft surfaces 235 and 233, respectively. Inner base member surface 254 is spaced from shaft surface 231 by gap 144, and inner clamping element surfaces 255 are spaced from shaft surface 234 by gap 145.

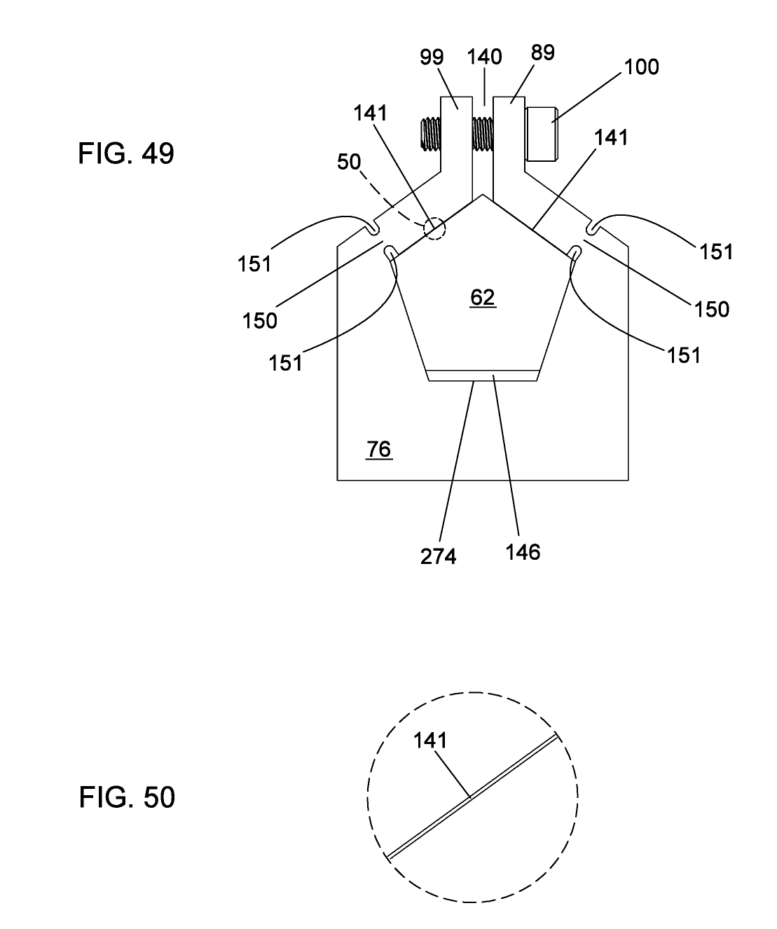

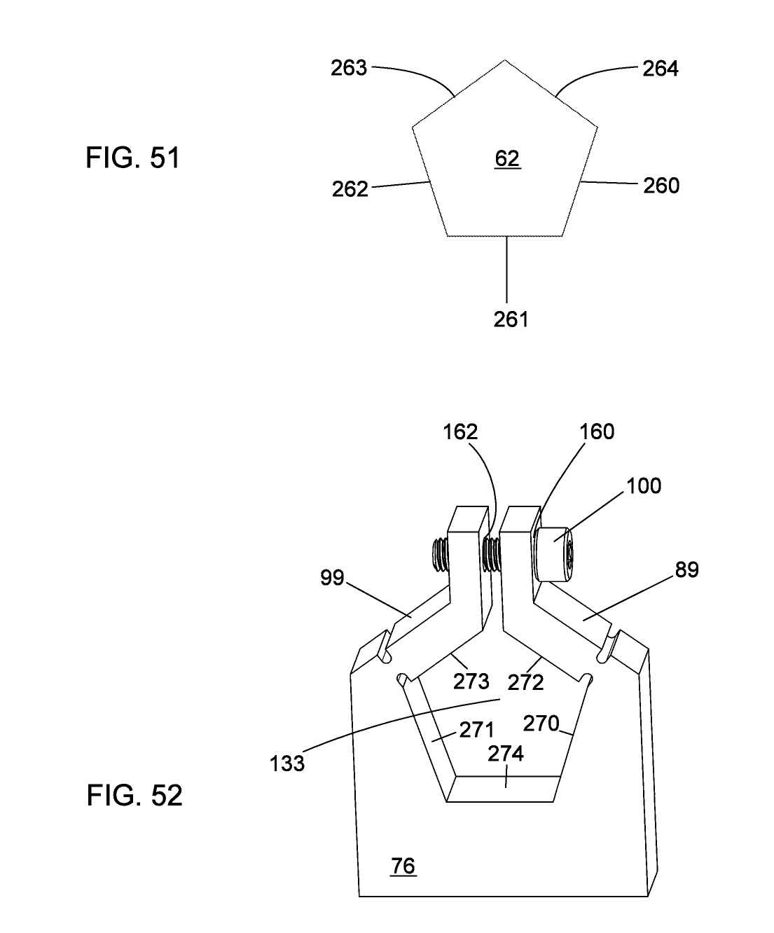

FIGS. 49, 50, 51, and 52 show an embodiment consistent with the inventive concept that is similar to that shown in FIGS. 5, 6, and 7, except that shaft 62 is pentagonal and base member 76 and clamping elements 89, 99 are shaped accordingly. The configuration of the base member and clamping elements is such that an aperture 133, with geometry that mates with the shaft 62, is provided. More particularly, inner base member surfaces 270 and 271 mate with shaft surfaces 260 and 262, respectively, while inner clamping element surfaces 272 and 273 mate with shaft surfaces 264 and 263, respectively. Inner base member surface 274 is spaced from shaft surface 261 by gap 146. The dimensional relationship between the aperture and the shaft is such that the gaps 141 offer a minimal clearance, permitting unlimited linear, but limited rotational motion along the shaft axis when the pinch bolt 100 is loose.

When the pinch bolt 100 is tightened, the clamping elements flex at live hinge points 150, and gaps 141 diminish in size, restricting rotational motion. With further tightening, the clamping elements make contact with the shaft and force the shaft into locking engagement and repeatable alignment with the base member.

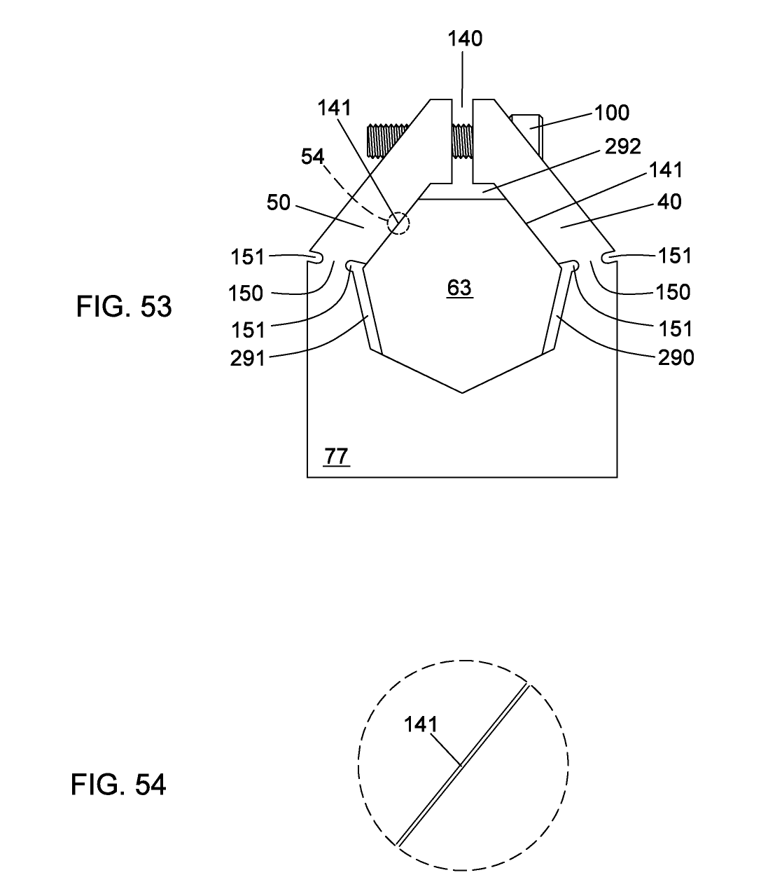

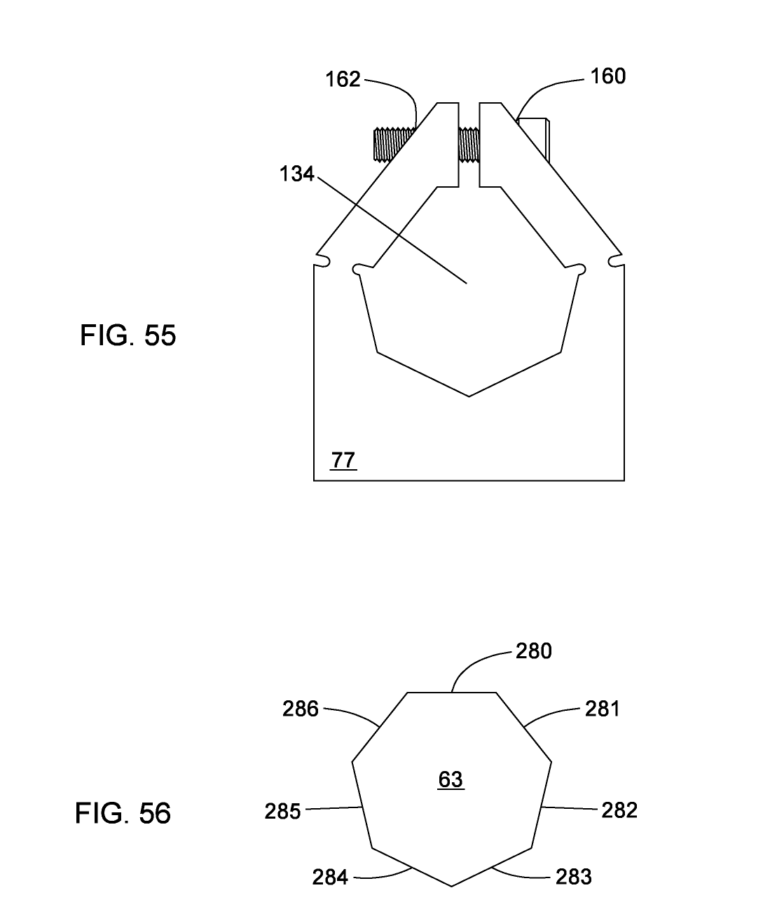

FIGS. 53, 54, 55, and 56 show an embodiment consistent with the inventive concept that is similar to that shown in FIGS. 5, 6, and 7, except that shaft 63 is heptagonal and base member 77 and clamping elements 40, 50 are shaped accordingly. The configuration of the base member and clamping elements is such that an aperture 134, with geometry that mates with the shaft 63, is provided. The base member is formed so as to mate with and contact shaft surfaces 283 and 284 and to be spaced from shaft surfaces 282 and 285 by gaps 290 and 291, respectively. The clamping elements 40, 50 are formed so as to mate with shaft surfaces 281, 286, respectively, and to be spaced from shaft surface 280 by gap 292. The dimensional relationship between the aperture and the shaft is such that the gaps 141 offer a minimal clearance, permitting unlimited linear, but limited rotational motion along the shaft axis when the pinch bolt 100 is loose.

When the pinch bolt 100 is tightened, the clamping elements flex at live hinge points 150, and gaps 141 diminish in size, restricting rotational motion. With further tightening, the clamping elements make contact with the shaft and force the shaft into locking engagement and repeatable alignment with the base member.

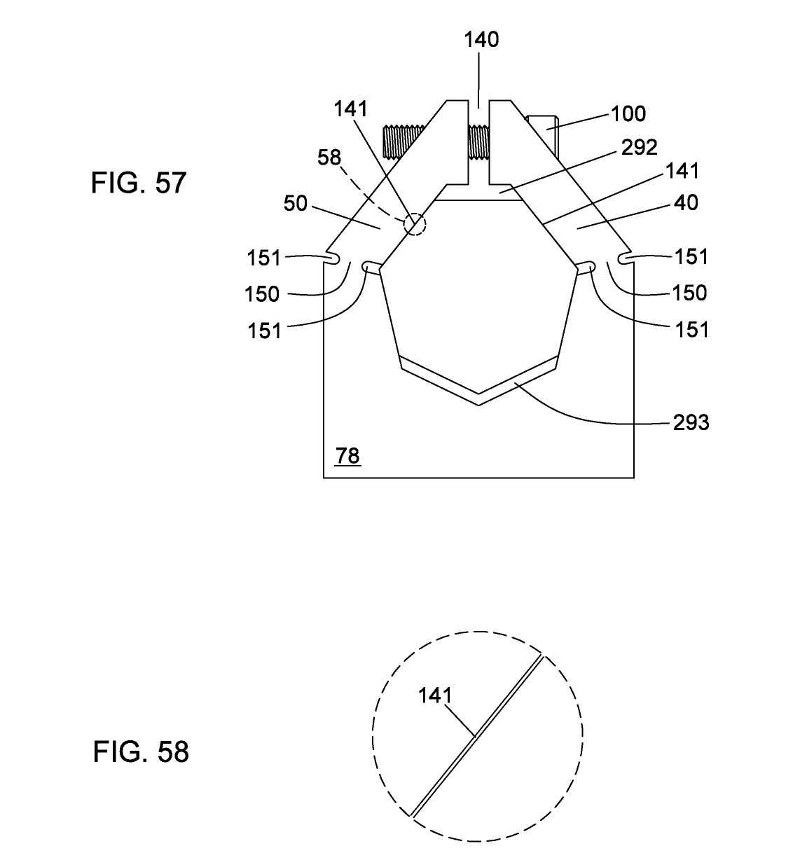

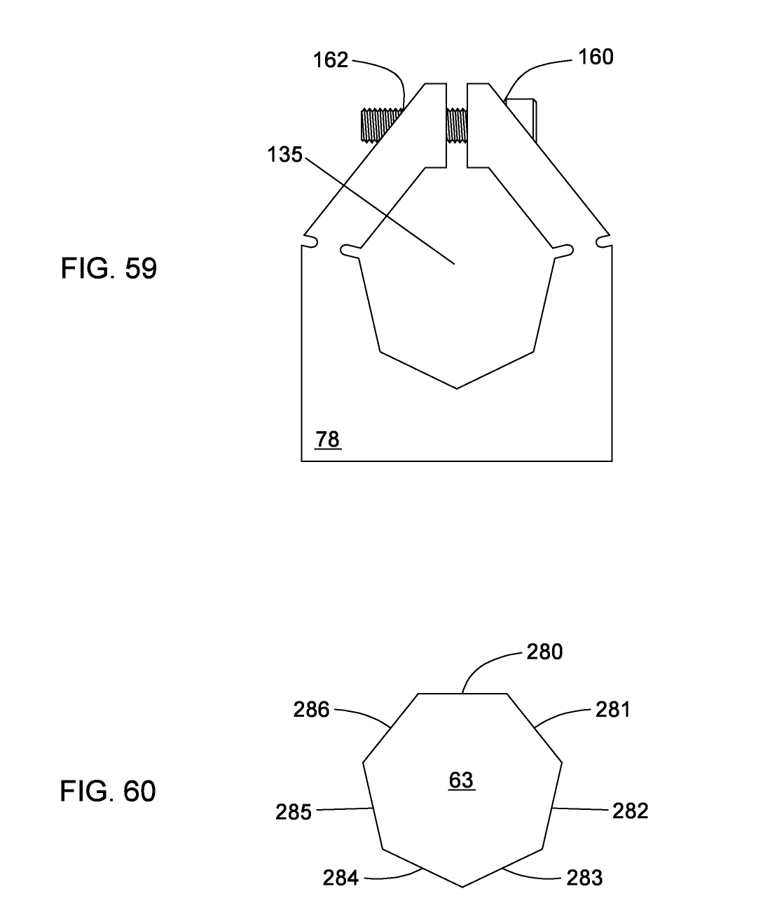

FIGS. 57, 58, 59, and 60 show an embodiment consistent with the inventive concept that is similar to that shown in FIGS. 53, 54, 55, and 56, except that base member 78 is formed so as to mate with and contact shaft surfaces 282 and 285 and to be spaced from shaft surfaces 283 and 284 by gap 293. The clamping elements 40, 50 are formed so as to mate with shaft surfaces 281, 286, respectively, and to be spaced from shaft surface 280 by gap 292. The configuration of the base member and clamping elements is such that an aperture 135, with geometry that mates with the shaft 63, is provided. The dimensional relationship between the aperture and the shaft is such that the gaps 141 offer a minimal clearance, permitting unlimited linear, but limited rotational motion along the shaft axis when the pinch bolt 100 is loose.

When the pinch bolt 100 is tightened, the clamping elements flex at live hinge points 150, and gaps 141 diminish in size, restricting rotational motion. With further tightening, the clamping elements make contact with the shaft and force the shaft into locking engagement and repeatable alignment with the base member.

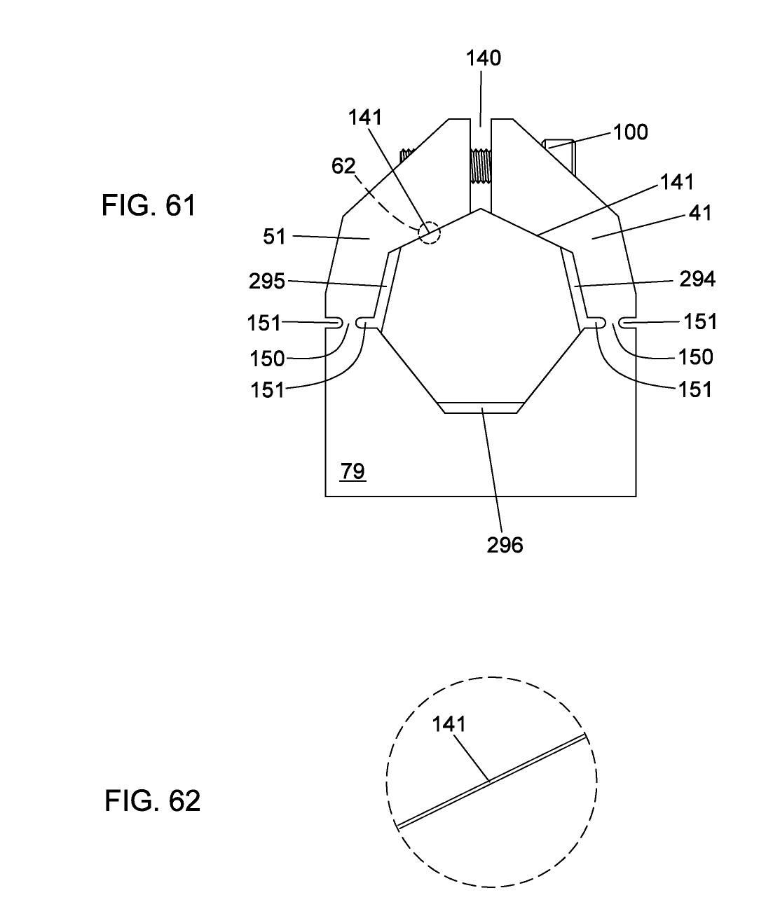

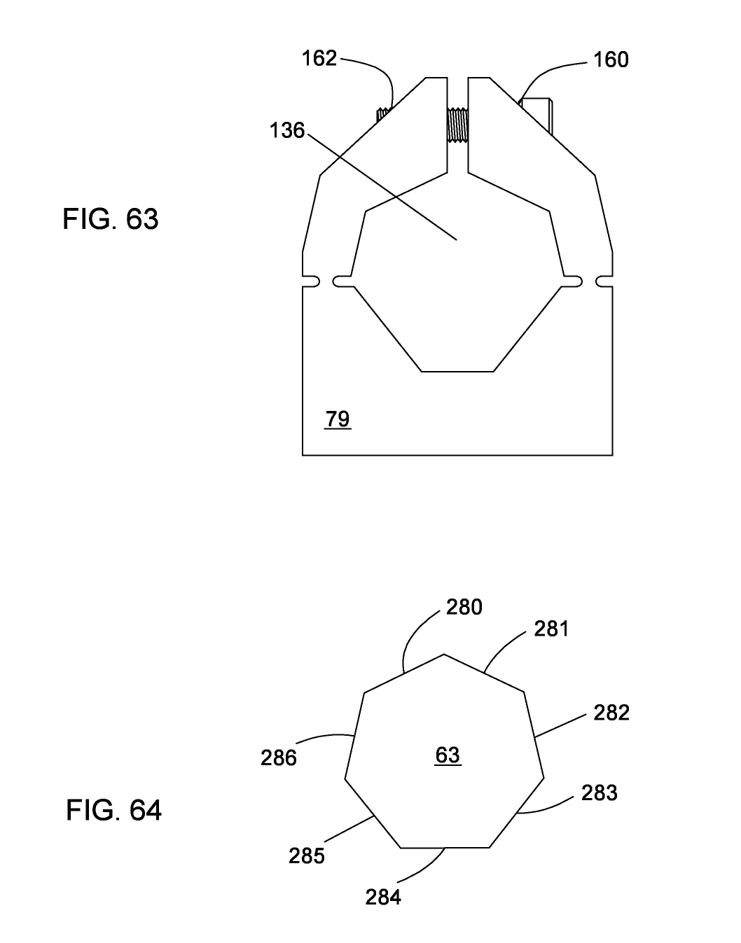

FIGS. 61, 62, 63, and 64 show an embodiment consistent with the inventive concept that is similar to that shown in FIGS. 53, 54, 55, and 56, except that base member 79 is formed so as to mate with and contact shaft surfaces 283 and 285 and to be spaced from shaft surface 284 by gap 296. The clamping elements 41, 51 are formed so as to mate with shaft surfaces 281, 280, respectively, and to be spaced from shaft surfaces 282, 286 by gaps 294, 295, respectively. The configuration of the base member and clamping elements is such that an aperture 136, with geometry that mates with the shaft 63, is provided. The dimensional relationship between the aperture and the shaft is such that the gaps 141 offer a minimal clearance, permitting unlimited linear, but limited rotational motion along the shaft axis when the pinch bolt 100 is loose.

When the pinch bolt 100 is tightened, the clamping elements flex at live hinge points 150, and gaps 141 diminish in size, restricting rotational motion. With further tightening, the clamping elements make contact with the shaft and force the shaft into locking engagement and repeatable alignment with the base member.

Although various exemplary embodiments have been described herein, those skilled in the art will understand that additional implicit variations and combinations may exist which lie within the scope and spirit of the inventive concept.

1. A clamping device which is connectable with a shaft having a longitudinal axis and four longitudinal surfaces extending in a direction parallel to the longitudinal axis, the clamping device comprising:
a base member having two substantially perpendicular surfaces, the base member being configured to contact two adjacent longitudinal surfaces of said four longitudinal surfaces of said shaft, wherein said base member extends along the shaft in the direction parallel to the longitudinal axis; and
a plurality of clamping elements, the plurality of clamping elements being coupled to said base member, wherein each of the plurality of clamping elements is flexible in a direction substantially perpendicular to the longitudinal axis of the shaft, and the plurality of clamping elements is operable to exert clamping pressure on the two adjacent longitudinal surfaces of said shaft opposing the base member.

2. The clamping device of claim 1, wherein the base member is L-shaped.

3. The clamping device of claim 1, wherein each of the plurality of clamping elements includes a hole to accommodate a connecting apparatus.

4. The clamping device of claim 3, wherein the connecting apparatus is at least one bolt which is insertable into the hole, and if the at least one bolt is tightened, the plurality of clamping elements is operable to increasingly exert the clamping pressure on the two adjacent longitudinal surfaces of said shaft opposing the base member.

5. The clamping device of claim 1, wherein the base member and the plurality of clamping elements are integrally formed.

6. The clamping device of claim 1, wherein the shaft is square.

7. A clamping device which is connectable with a multi-sided shaft having a longitudinal axis and a plurality of longitudinal surfaces extending in a direction parallel to the longitudinal axis, the clamping device comprising:
a base member having a plurality of substantially surfaces extending in the direction parallel to the longitudinal axis, the base member being configured to contact at least two adjacent longitudinal surfaces of said plurality of longitudinal surfaces of said multi-sided shaft, wherein said base member extends along the multi-sided shaft in the direction parallel to the longitudinal axis; and
a plurality of clamping elements, the plurality of clamping elements being coupled to said base member, wherein each of the plurality of clamping elements is flexible in a direction substantially perpendicular to the longitudinal axis of the multi-sided shaft, and the plurality of clamping elements is operable to exert clamping pressure on the at least two adjacent longitudinal surfaces of said multi-sided shaft opposing the base member.
